(19) United States
(12) Patent Application Publication
(10) Pub. No.: US 2003/0220888 A1
(43) Pub. Date: Nov. 27, 2003

(54) System and method for estimating document transportation costs

(76) Inventors: Dana S. Smith, Dana Point, CA (US); Uoc H. Nguyen, Long Beach, CA (US)

Correspondence Address: David C. Ripma, Patent Counsel, Sharp Laboratories of America, Inc., 5750 NW Pacific Rim Boulevard, Camas, WA, 98607, US

(21) Appl. No.: 10/153,933

(22) Filed: May 23, 2002

(51) Int. Cl. G06G 7/00; G06F 17/00

(52) U.S. Cl. 705/407; 705/400

(57) ABSTRACT

A system and method are provided for estimating the weight of a document. The method comprises: determining the paper basis; determining the paper size; determining a document page count; and, in response to the determinations, calculating the weight of the printed document. In some aspects the method further comprises: determining the weight of the ink; and, determining the weight of the fuser oil, so that the calculated weight of the printed document includes the determined ink weight and fuser oil weight. In other aspects the method further comprises: selecting a transportation carrier; and, determining the transportation charges associated with the printed document using the calculated document weight. Some aspects further comprise: in response to selecting a carrier, selecting a document package. Then, calculating the weight of the printed document includes adding the weight of the selected package to the document weight.

### BACKGROUND OF THE INVENTION

1. Field of the Invention

This invention generally relates to document processing and, more particularly, to a system and method for estimating the weight of paper documents for franking or carrier shipment purposes.

2. Description of the Related Art

A printed document that is to be sent via a postal service or private letter carrier is typically weighed as part of the preparation for shipment. This process requires the use of a weighing device such as a scale or balance. Without such equipment, it is difficult to know the amount of postage required or the expected shipping cost. However, many small businesses do not have scales. Not only must there be scales on the premises, but a schedule of current postal rates is required. Even if a current rate schedule is maintained, at least one employee must be able to calculate the postage due from the rates and the weight.

A conventional in-house postage system when properly used provides precision data based upon the mechanical or electronic weighing devices. However, such a system is only concerned with the determination of transportation costs and does not offer a priori cost reduction strategies.

It would be advantageous if a document processing system were able to suggest document delivery cost reduction strategies, as the documents were being prepared.

It would be advantageous if a document processing system could suggest document formatting options, cross-referenced to delivery costs.

### SUMMARY OF THE INVENTION

This present invention permits small businesses or individual users to avoid the cost of precision postal scales by inferring the weight of a document from other known properties. Since most common franking or shipping rate schedules round to well-spaced increments, a reasonable estimated weight suffices in determining the franking or weight statement requirement. Typically, these schedules also include dimension requirements that can be combined with the known document size properties to arrive at an estimated postage amount.

Additionally, the present invention allows users to realize cost savings by bringing to their attention overweight, or near limit documents. In response, the user may elect to change the document composition or pagination to minimize the cost of transport, whether the document is sent as paper or electronically.

While conventional postage systems are concerned with precise methods using mechanical or electronic weighing devices, the present invention provides an imprecise, but sufficient estimate of the weight of the documents to be transported. It does so without the use of any mass or weight detection devices.

Additionally, the present invention offers an intelligent advisory function in the determination of document transportation costs. The transportation analyzer permits the format and nature of the document to be adjusted to minimize transportation costs. Also, portions of the cost determination related to the page count or occupancy may be applied to the determination of non-physical transport, such as facsimile transmission.

Accordingly, a method is provided for estimating the weight of a document. The method comprises: determining the paper basis; determining the paper size; determining a document page count; and, in response to the determinations, calculating the weight of the printed document.

In one aspect of the method, the paper basis and paper size are determined by directing a query requesting the paper basis and paper size to a user interface. Then, the user inputs the paper basis and size data. Alternately, a query requesting the paper basis and paper size is directed from a printer driver to an associated printer, and the printer returns the query results after measuring the paper currently in use.

The document page count is determined by: directing a query to a printer driver requesting the document page count. In some aspects, the printer driver establishes bi-directional communications with an associated printer to calculate local printer adjustments in the document length. In some aspects the method further comprises: determining the weight of the ink; and, determining the weight of the fuser oil, so that the calculated weight of the printed document includes the determined ink weight and fuser oil weight.

In other aspects the method further comprises: selecting a transportation carrier; and, determining the transportation charges associated with the printed document using the calculated document weight. Some aspects further comprise: in response to selecting a carrier, selecting a document package. Then, calculating the weight of the printed document includes adding the weight of the selected package to the document weight.

Additional details of the above-described method, and a system for estimating the weight of a document are proved below.

### BRIEF DESCRIPTION OF THE DRAWINGS

FIG. 1 is a schematic block diagram of the present invention system for estimating the weight of a document.

FIG. 2 is a flowchart illustrating the present invention method for estimating document transportation costs.

FIGS. 3a and 3b are flowcharts illustrating the present invention method for estimating the weight of a document.

### DETAILED DESCRIPTION OF THE PREFERRED EMBODIMENTS

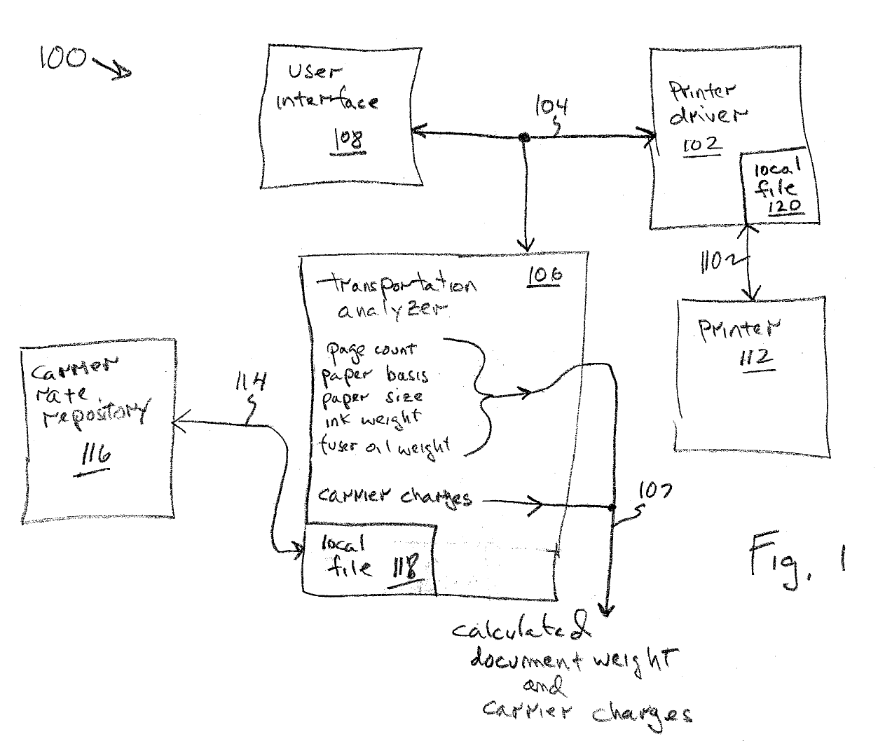

FIG. 1 is a schematic block diagram of the present invention system for estimating the weight of a document. The system 100 comprises a printer driver 102 having a port on line 104 to accept documents for printing and to supply documents page count information. It should be understood that a “port”, as used herein, includes any type of conventional or virtual network connection, such as a direct hardwire, local area network (LAN), wide area network (WAN), the Internet, an intranet, or the like. The documents can be supplied by a conventional word processing application (not shown). A transportation analyzer 106 has a port to accept paper basis information and paper size information and to accept document page count information from the printer driver 102. The transportation analyzer 106 has an output on line 107 to supply the calculated weight of a printed document in response to paper basis, paper size, and document page count information. For example, the calculated weight can be displayed on the screen of an associated personal computer.

As is well known in the art, the printer driver 102 is fundamentally enabled through software. Likewise, key elements of the transportation analyzer 106 are enabled with software routines. In some aspects, the above-mentioned elements are all software applications loaded into a personal computer. In other aspects, the printer driver can be a software application loaded onto a printer.

In some aspects of the system 100, the transportation analyzer generates paper basis and paper size inquiries. One example of a paper weight is “20 lb.” and one example of paper size is “8½ by 11 inches”. This aspect the system 100 further comprises a user interface 108 having a port on line 104 to accept the paper basis and paper size queries from the transportation analyzer 106 and to supply paper basis and paper size information to the transportation analyzer 106 from user responses to the query. For example, the inquiries could be directed to a user interface display and a user, after checking the paper in a printer, can use a keyboard to enter the requested data.

In other aspects of the system 100, the printer driver 102 can generate a query requesting the paper basis and paper size information on line 110. The system includes at least one printer 112 having a port on line 112 to receive the paper basis and paper size query from the printer driver 102 and to supply query results. The above-mentioned ports would also be used to deliver the document to the printer to create a hardcopy of the document. In some aspects of the system 100, the printer 112 includes equipment (not shown) to measure the paper basis and paper size. The printer 112 returns query results to the printer driver 102 in response to the measurements.

Before calculating the document weight, the transportation analyzer 106 directs a query to the printer driver 102 requesting the document page count and receives page count query results from the printer driver 102. In some aspects, the printer driver 102 establishes bi-directional communications with the printer 112, and in response calculates local printer adjustments in the document length. These communications permit an accurate page count to be made even when the system does not use a standard printer or standardized printer format.

In some aspects of the system 100, the transportation analyzer 106 determines the weight of the ink used to print the document and calculates the weight of the printed document using the determined ink weight. In other aspects the transportation analyzer 106 determines the weight of the fuser oil used to print the document and calculates the weight of the printed document using the determined fuser oil weight. The ink and fuser oil determinations may be made in response to communications with the printer driver 102 to collect relevant information such as font size, the number of words per page of the document, or some other indication of the amount of ink used per page.

In some aspects of the system the transportation analyzer 106 has an output on line 107 to supply transportation charges determined from the calculated weight of the associated printed document. For example, based on the assumption that the document is to be sent via US Post Office Express Mail, a calculation of the shipping charges is made using the determined document weight.

In other aspects, the transportation analyzer 106 has an input on line 104 to accept transportation carrier selections. These selections can be made via user interface prompts for example. Alternately, the transportation analyzer is programmed with default carrier selections. The transportation analyzer 106 supplies a determination of the charges for transporting the printed document via the selected carrier. The transportation carriers considered can be either a paper delivery service, such as the Post Office or Federal Express, or a facsimile (fax) communication of the printed document. When a fax communication is selected, the transportation analyzer must make a calculation based upon phone rates and the estimated time to complete the transmission.

In one aspect of the system 100, the transportation analyzer 106 includes a port on line 114 for establishing a communication linkage to at least one carrier rate repository 116. For example, the transportation analyzer 106 can include a browser (not shown) and the communication linkage 114 can be the Internet. A local file 118 can be used for storing carrier rates downloaded via the communication linkage. The transportation analyzer 106 accesses the carrier rates in the local file 118 to determine the charges for transporting the printed document via the selected carrier. Alternately, the carrier rate repository 116 can be queried for each carrier charge calculation.

Alternately, the printer driver 102 includes a local file 120 of carrier rates. The local file can be updated through network communications with a carrier rate repository, by downloading information by a disk, or by manual user inputs. The transportation analyzer 106 accesses the carrier rates in the printer driver local file 120 to determine the charges of transporting the printed document via the selected carrier.

In other aspects of the system 100, the transportation analyzer 106 selects a document package in response to a carrier selection, and calculates the weight of the printed document by adding the weight of the selected package to the document weight. For example, US Express Mail shipments are made in a stiff cardboard envelope. Once US Express Mail is selected as the carrier, the weight of the cardboard envelope can be added to the calculated documents weight.

In some aspects of the system 100 the transportation analyzer 106 calculates the printed document form factor and accepts a document package selection in response to the calculated form factor. For example, the transportation analyzer may make a determination that a 500 page document will not fit in a US Express Mail envelope. In response, an alternate package will be selected that can contain a 500 page document. Likewise, the transportation analyzer may select a different carrier or a different type of service in response to document form factors.

In some aspects of the system 100, the transportation analyzer 106, following the calculating of the weight of the printed document, determines alternate document formatting options, and calculates a document weight for each of the alternate document formatting options. Further, the transportation analyzer 106 calculates a corresponding transportation cost in response to each of the alternate document formatting options.

### Functional Description

This present invention uses information provided by the user, a printer driver, and/or a printer to derive an estimated weight of a printed document. From the user, the paper basis weight and paper type is learned by query. From the printer driver, the printed page count and pagination specifics of a document are learned. Specifically, the information is supplied by a driver and printing software application program interface (API). From the printer, through bi-directional communication with its driver, the page count and paper size actually used in physically generating the document, as well as potential local adjustments to the document generation, such as 2-sided or multiple pages/sheet printing, can be learned. From printers so equipped, it may also be possible to learn media thickness, gloss, or other properties such as printing area coverage, that may influence the weight calculations.

From all of this information, the costs associated with the physical transportation of the printed document is derived and presented in the form of advice to the user. This information is useful in cost and delivery time tradeoff decisions. Once the page count is known, the paper size, basis weight, and page count may be used to arrive at the first approximation of document weight by using the formula:

W1=Weight_{basis}×Paper_{width}×Paper_{height}×Count

where the basis weight is expressed in mass per unit area and the paper dimensions are in the matching linear measure for the area unit in use. For example, basis in grammage/meter2 would use paper in fractional meter measure, such as 75 g/m²×0.210 m×0.297 m×10 pages=46.78 g.

Following this step, an improved estimate is generated by adding compensation amounts for the mass of toner or ink added to the pages, and for fuser oil uptake in electrophotographic output.

Since toners have a slight mass, and ink systems leave non-evaporative constituents, a compensating mass value is derived by either using a fixed average amount, or from an imaged area value calculation returned by the print engine. In the case of printing systems using fusers with fuser oils, a small amount of fuser oil is absorbed by the paper, adding the weight to the document. While both the ink and fuser oil are added in small quantities, their effect is cumulative and may be significant for large page count documents.

W2=Weight/pixel×pixels/page×Count

W3=Weightₒᵢₗ/page×Count

Where, again, the units of measure are kept consistent with the calculation of W1.

Following these calculations, the estimated weight of the document is determined by summing the three weights. Since paper basis weight is determined at the mill in controlled ambient conditions, and contain some percentage of error, a conservation factor may also be added to avoid a serious underestimation of the document weight. By empirical analysis an error of ˜2% appears normal, so a 3% uplift can be applied to the estimate for example.

Estimate_{document}=(W1+W2+W3)*1.03

At this point the document weight estimate may be reported to the end user, and additionally a localized version of a franking charge may be calculated based on previously established schedules. Since the actual schedule of rates, and special case charges, vary greatly between national agencies, another feature of this invention is to provide a linkage to an agency, such as a postal service or a private commercial carrier. The linkage permits the downloading the data necessary to calculate a franking or shipment charge. Currency display can include multiple currencies as well; for instance, both a local national currency and Euros, in the case of European nations.

Alternatively, the rate schedules of postage can be included in the printer driver by the manufacturer/distributor on a localized basis. This relieves the user from the responsibility of data entry, and can be kept current and updated by the manufacturer/distributor, or likewise made available for download from a customer service website or similar support method.

For some carriers, additional data, such as the weight of standard shipment containers, might also be obtained. Since the final shipping weight of a document includes the packaging materials, which is information not immediately available, this information permits the calculation of charges to be based on the container dimensions, characteristic weight, and the document to be enclosed.

The resulting shipping weight and charges estimate can be communicated to the user at the time of document printing through the driver to the user's host computer. Additionally, the document weight estimate can be routinely printed on a job separator or banner sheet, and one or more shipping cost estimates for the document as well. Many of these calculations can be embodied as lookup tables, with pre-calculated values, so that there is no significant impact on print device job performance.

In one variation of the invention, an additional calculation is performed to compare the costs of reformatted pagination, for instance, to reduce the page count, or page size. This calculation may demonstrate the effect of a lower basis weight paper stock, to permit the document to fit a lower rate schedule category for example. In this variation, all calculations are presumptive and made in advance of actual printing, and communicated to the user in a dialog box from the printer driver or the transportation analyzer application, thus permitting the information to be used in actual printing decisions.

In yet another variation, the pagination and schedule analysis might be done for a print-to-facsimile driver, where the rate calculation includes the telephonic transportation of the document and the data transmission rate to minimize the telephonic connection time for the sender and consumables usage at the recipient site.

Additionally, in any of the above-mentioned variations, a user could optionally enter constraints or rules imposed by regulation or industry to eliminate incompatible document modifications.

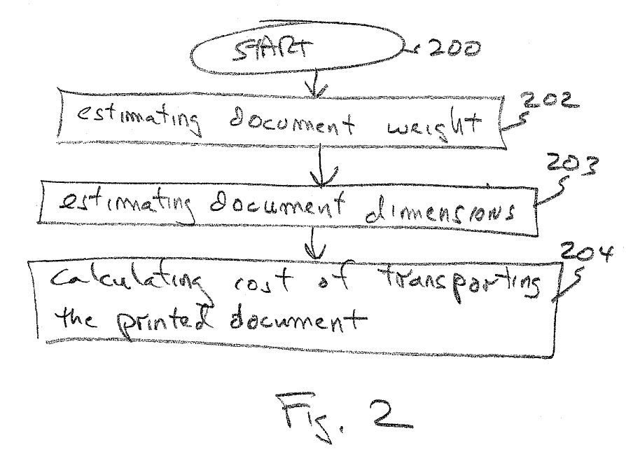

FIG. 2 is a flowchart illustrating the present invention method for estimating document transportation costs. Although this method (and the method described below) is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 200. Step 202, prior to printing a document, estimates the document weight. Step 204, in response to the estimated weight, calculates the cost of transporting the printed document.

In some aspects of the method a further step, Step 203, estimates the document dimensions. Then, calculating the cost of transporting the printed document in Step 204 includes calculating in response to the estimated document dimensions.

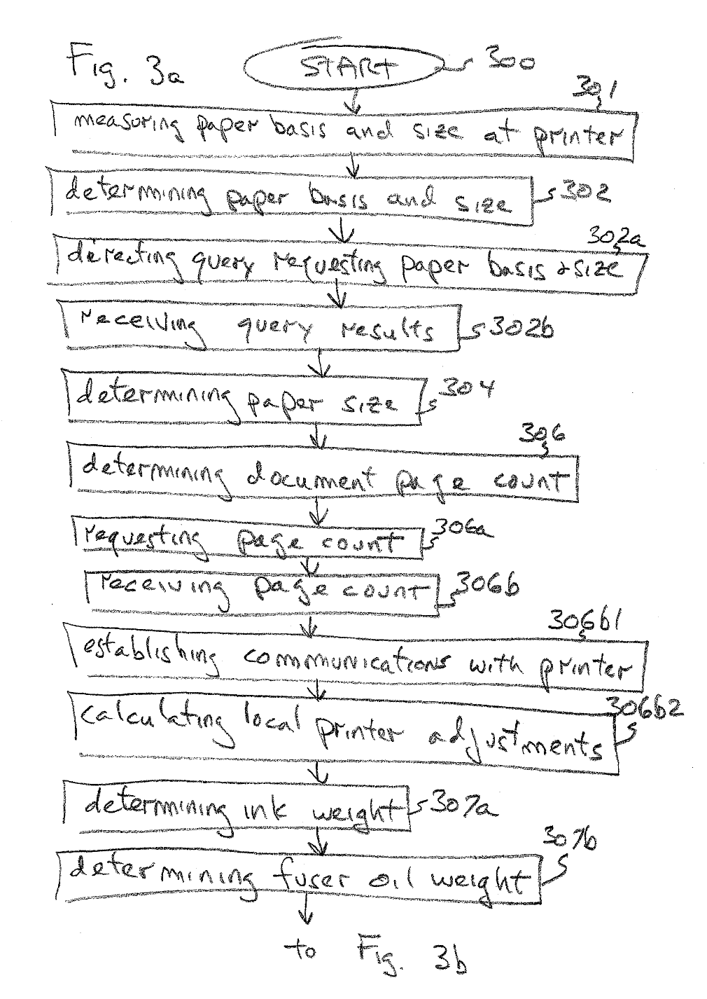

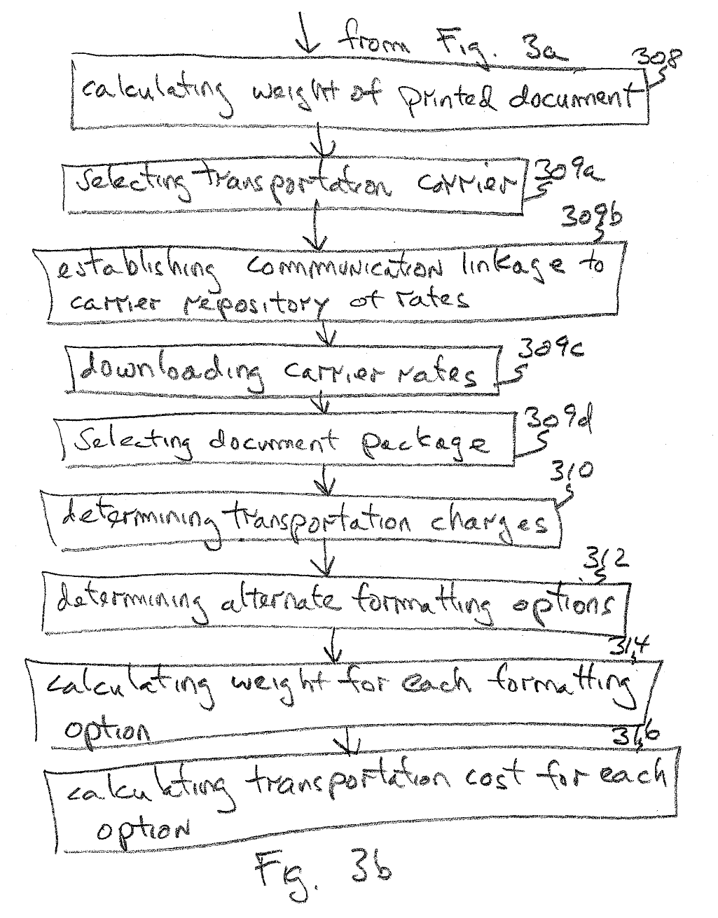

FIGS. 3a and 3b are flowcharts illustrating the present invention method for estimating the weight of a document. The method starts at Step 300. Step 302 determines the paper basis. Step 304 determines the paper size. Step 306 determines a document page count. Step 308, in response to the determinations, calculates the weight of the printed document.

In some aspects of the method, determining the paper basis and paper size in Steps 302 and 304 includes substeps. Step 302a directs a query requesting the paper basis and paper size to a user interface. Step 302b receives query results from the user interface. Alternately, Step 302a directs a query requesting the paper basis and paper size from a printer driver to an associated printer, and Step 302b receives query results from the printer. In some aspects Step 301 measures the paper basis and paper size at the printer. Then, receiving query results from the printer in Step 302b includes receiving query results in response to the printer measurements.

In some aspects, determining the document page count in Step 306 includes substeps. Step 306a directs a query to a printer driver requesting the document page count. Step 306b receives page count query results from the printer driver. Receiving page count query results from the printer driver in Step 306b can include additional steps. Step 306b1 establishes bi-directional communications between the printer driver and an associated printer. Step 306b2 calculates local printer adjustments in the document length.

In some aspects of the method a further step, Step 307a determines the weight of the ink. Then, calculating the weight of the printed document in Step 308 includes adding the determined ink weight. Likewise, when the printer user fuser oil, Step 307b determines the weight of the fuser oil and Step 308 calculates the weight of the printed document by adding the determined fuser oil weight.

In some aspects a further step, Step 310, using the calculated weight, determines the transportation charges associated with the printed document. In some aspects, Step 309a selects a transportation carrier. The carrier can be a paper delivery service or a facsimile communication of the document. Then, determining the transportation charges associated with the printed document in Step 310 includes determining the charges of transporting the printed document via the selected carrier.

In one aspect of the method Step 309b establishes a communication linkage to at least one carrier rate repository. Step 309c downloads the carrier rates to a local file. Then, determining the charges of transporting the printed document via the selected carrier in Step 310 includes accessing the local file to determine the carrier rates. Alternately but not shown, the method comprises the step of maintaining a local file of carrier rates in the printer driver. Then, determining the charges of transporting the printed document via the selected carrier in Step 310 includes accessing the printer driver local file to determine the carrier rates.

Step 309d, in response to selecting a carrier, selects a document package. Then, calculating the weight of the printed document in Step 308 includes adding the weight of the selected package to the document weight. In other aspects, calculating the weight of the printed document includes calculating the printed document form factor. Then, selecting a document package in Step 309d includes selecting a document package in response to the calculated form factor.

Step 312, following the calculating of the weight of the printed document, determines alternate document formatting options. Step 314 calculates a document weight for each of the alternate document formatting options. Step 316, in response to each of the alternate document formatting options, calculates a corresponding transportation cost.

A system and method for estimating document weights and transportation costs have been provided. A few examples have been provided has to how such determination could be made. However, the present invention is not limited to merely these examples. Examples have also been given of uses for the present invention. Once again, the present invention is not limited to just these uses. Other variations and embodiments of the present invention will occur to those skilled in the art.

We claim:

1. A method for estimating document transportation costs, the method comprising:
prior to printing a document, estimating the document weight; and,
in response to the estimated weight, calculating the cost of transporting the printed document.

2. The method of claim 1 further comprising:
estimating the document dimensions; and,
wherein calculating the cost of transporting the printed document includes calculating in response to the estimated document dimensions.

3. A method for estimating the weight of a document, the method comprising:
determining the paper basis;
determining the paper size;
determining a document page count; and,
in response to the determinations, calculating the weight of the printed document.

4. The method of claim 3 wherein determining the paper basis and paper size includes:
directing a query requesting the paper basis and paper size to a user interface; and,
receiving query results from the user interface.

5. The method of claim 3 wherein determining the paper basis and the paper size includes:
directing a query requesting the paper basis and paper size from a printer driver to an associated printer; and,
receiving query results from the printer.

6. The method of claim 5 further comprising:
at the printer, measuring the paper basis and paper size; and,
wherein receiving query results from the printer includes receiving query results in response to the printer measurements.

7. The method of claim 3 wherein determining the document page count includes:
directing a query to a printer driver requesting the document page count; and,
receiving page count query results from the printer driver.

8. The method of claim 7 wherein receiving page count query results from the printer driver includes:
establishing bi-directional communications between the printer driver and an associated printer; and,
calculating local printer adjustments in the document length.

9. The method of claim 3 further comprising:
determining the weight of the ink; and,
wherein calculating the weight of the printed document includes adding the determined ink weight.

10. The method of claim 3 further comprising:
determining the weight of the fuser oil; and,
wherein calculating the weight of the printed document includes adding the determined fuser oil weight.

11. The method of claim 3 further comprising:
using the calculated weight, determining the transportation charges associated with the printed document.

12. The method of claim 11 further comprising:
selecting a transportation carrier; and,
wherein determining the transportation charges associated with the printed document includes determining the charges of transporting the printed document via the selected carrier.

13. The method of claim 12 wherein selecting a transportation carrier includes selecting a carrier selected from the group including paper delivery services and facsimile communication of the printed document.

14. The method of claim 12 further comprising:
establishing a communication linkage to at least one carrier rate repository;
downloading the carrier rates to a local file; and,
wherein determining the charges of transporting the printed document via the selected carrier includes accessing the local file to determine the carrier rates.

15. The method of claim 12 further comprising:
maintaining a local file of carrier rates in the printer driver; and,
wherein determining the charges of transporting the printed document via the selected carrier includes accessing the printer driver local file to determine the carrier rates.

16. The method of claim 12 further comprising:
in response to selecting a carrier, selecting a document package; and,
wherein calculating the weight of the printed document includes adding the weight of the selected package to the document weight.

17. The method of claim 16 wherein calculating the weight of the printed document includes calculating the printed document form factor; and,
wherein selecting a document package includes selecting a document package in response to the calculated form factor.

18. The method of claim 3 further comprising:
following the calculating of the weight of the printed document, determining alternate document formatting options; and,
calculating a document weight for each of the alternate document formatting options.

19. The method of claim 18 further comprising:
in response to each of the alternate document formatting options, calculating a corresponding transportation cost.

20. A system for estimating the weight of a document, the system comprising:
a printer driver having a port to accept documents for printing and to supply documents page count information; and
a transportation analyzer having a port to accept paper basis information and paper size information, to accept document page count information from the printer driver, and an output to supply the calculated weight of a printed document in response to paper basis, paper size, and document page count information.

21. The system of claim 20 wherein the transportation analyzer generates paper basis and paper size inquiries; and,
the system further comprising:
a user interface having a port to accept the paper basis and paper size queries from the transportation analyzer and to supply paper basis and paper size information to the transportation analyzer from user responses to the query.

22. The system of claim 20 wherein the printer driver generates a query requesting the paper basis and paper size information; and,
the system further comprising:
a printer having a port to receive the paper basis and paper size query from the printer driver and to supply query results.

23. The system of claim 22 wherein the printer includes equipment to measure the paper basis and paper size, the printer returning query results to the printer driver in response to the measurements.

24. The system of claim 22 wherein the transportation analyzer directs a query to the printer driver requesting the document page count and receives page count query results from the printer driver.

25. The system of claim 24 wherein the printer driver establishes bi-directional communications with the printer and in response calculates local printer adjustments in the document length.

26. The system of claim 20 wherein the transportation analyzer determining the weight of the ink used to print the document and calculates the weight of the printed document using the determined ink weight.

27. The system of claim 20 wherein the transportation analyzer determining the weight of the fuser oil used to print the document and calculates the weight of the printed document using the determined fuser oil weight.

28. The system of claim 20 wherein the transportation analyzer supplies transportation charges determined from the calculated weight of the associated printed document.

29. The system of claim 28 wherein the transportation analyzer accepts transportation carrier selections and supplies a determination of the charges for transporting the printed document via the selected carrier.

30. The method of claim 29 wherein the transportation analyzer accepts transportation carrier choices selected from the group including paper delivery services and facsimile communication of the printed document.

31. The system of claim 29 wherein the transportation analyzer includes a port for establishing a communication linkage to at least one carrier rate repository and a local file for storing carrier rates downloaded via the communication linkage, the transportation analyzer accessing the carrier rates in the local file to determine the charges for transporting the printed document via the selected carrier.

32. The system of claim 29 wherein the printer driver includes a local file of carrier rates; and,
wherein the transportation analyzer accesses the carrier rates in the printer driver local file to determine the charges of transporting the printed document via the selected carrier.

33. The system of claim 29 wherein the transportation analyzer selects a document package in response to a carrier selection and calculates the weight of the printed document by adding the weight of the selected package to the document weight.

34. The system of claim 33 wherein the transportation analyzer calculates the printed document form factor and accepts a document package selection in response to the calculated form factor.

35. The system of claim 20 wherein the transportation analyzer, following the calculating of the weight of the printed document, determines alternate document formatting options, and calculates a document weight for each of the alternate document formatting options.

36. The system of claim 35 wherein the transportation analyzer calculates a corresponding transportation cost in response to each of the alternate document formatting options.
